(19) United States
(12) Patent Application Publication
(10) Pub. No.: US 2026/0126859 A1
(43) Pub. Date: May 7, 2026

(54) METHOD FOR GESTURE-BASED CONTROL OF ELECTRONIC DEVICES

(71) Applicant: T-MOBILE INNOVATIONS LLC, Overland Park, KS (US)

(72) Inventors: Kirthi Arjun PUCHA, Monroe, WA (US); Jhon Nelson SIHOTANG, Renton, WA (US)

(21) Appl. No.: 18/939,973

(22) Filed: Nov. 7, 2024

(51) Int. Cl. G06F 3/01; G06F 3/0346; G06V 40/20

(52) U.S. Cl. CPC G06F 3/017; G06F 3/011; G06F 3/0346; G06V 40/28

(57) ABSTRACT

Embodiments of the present disclosure are directed to systems and methods for gesture-based command control of electronic devices. The invention integrates multiple sensors and cameras with machine learning algorithms to accurately detect and interpret user gestures and verbal commands. Sensors embedded in wearable devices, cameras positioned in the user's environment, and user equipment (UE) capture hand and finger movements and visual data. These inputs are processed using neural networks to recognize specific gestures and interpret verbal commands. The recognized gestures and commands are then translated into actions for connected devices, facilitating intuitive and efficient control.

### SUMMARY

The present disclosure is directed, in part, to methods and systems for detecting and interpreting user gestures to control connected electronic devices, substantially as shown and/or described in connection with the figures. This disclosure provides innovative mechanisms for integrating multiple data sources and employing advanced machine learning techniques to enable seamless and intuitive user interactions with connected devices.

According to various aspects of the technology, the disclosed methods introduce solutions to the problem of accurately interpreting user inputs in a connected environment. By implementing a system capable of detecting user gestures through sensors embedded in wearable devices and capturing gestures via multiple cameras or other motion-capturing devices (e.g., RADAR devices, LIDAR devices, etc.), the disclosed methods and systems ensure that user intents can be precisely understood and executed. These outcomes are achieved through a method where sensors monitor hand and finger movements while cameras capture visual data. Machine learning algorithms are used to recognize specific gestures. The recognized gestures are then translated into commands for connected devices, enabling efficient and accurate execution of user intentions.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates an exemplary network environment in which implementations of the present disclosure may be employed;

FIG. 4 illustrates an exemplary network environment in which implementations of the present disclosure may be employed; and

FIG. 5 illustrates a flow diagram of an exemplary method for communicating with connected electronic devices.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Modern connected electronic devices and smart home environments rely heavily on accurate and intuitive user interfaces to enhance user experience and device control. A critical component in enabling these interactions is the ability to detect and interpret user gestures and verbal commands. Users of smart home systems often require seamless and efficient control over multiple connected devices, such as lighting, heating, entertainment systems, and security features, using natural and intuitive methods of interaction.

Conventionally, achieving accurate and reliable gesture and verbal command recognition has been challenging due to the limitations of existing sensor technologies and the complexity of integrating multiple input modalities. Traditional methods often rely on isolated systems that do not fully leverage the potential of combining verbal and gesture inputs. These methods may lack the real-time processing capabilities and adaptive learning features required to provide a truly seamless user experience. As a result, there is a gap in the ability to offer integrated, intuitive, and responsive control of connected devices, leading to user frustration and inefficiencies.

In contrast to conventional solutions, the present disclosure provides a method that leverages advanced machine learning algorithms and multi-sensor fusion to enhance the detection and interpretation of user gestures. The disclosed method includes sensors embedded in wearable devices, such as accelerometers, gyroscopes, magnetometers, and optical sensors, for detecting hand and finger movements in real-time. Additionally, the system employs multiple motion-capturing devices (e.g., RADAR devices, LIDAR devices, or optical cameras), including personal cameras attached to the user's body, smart glasses, and fixed cameras in the environment, to capture comprehensive visual data of the user's gestures from various angles. By integrating these diverse inputs, the system utilizes machine learning algorithms to analyze and recognize specific gestures with high accuracy. Once the gestures are identified, the system translates them into corresponding commands using a secondary machine learning model that continuously learns and adapts based on user feedback. These commands are then securely transmitted to connected electronic devices, such as smart speakers, lights, or thermostats, ensuring precise and intuitive execution of user intentions. This integrated approach provides a seamless and responsive user experience, significantly improving the accuracy and reliability of gesture-based control systems.

Accordingly, a first aspect of the present disclosure provides a method for controlling electronic devices using gestures. This method comprises a series of steps designed to detect, capture, analyze, translate, and execute user-specific gestures. The method begins with detecting one or more hand or finger movements of a user, where the detection is performed by one or more sensors integrated into a wearable device worn by the user. Following this, the method involves capturing one or more gestures of the user using one or more cameras positioned either on the user or in the user's environment to provide multiple angles of view. The next step is analyzing the detected hand or finger movements and the captured gestures using a processing module to recognize a plurality of user-specific gestures. The recognized gestures are then translated into one or more commands for a plurality of connected electronic devices using a machine learning algorithm. Finally, the method causes the one or more commands to be executed on the plurality of connected devices, enabling seamless and intuitive control over these devices.

In a second aspect of the present disclosure, a system for controlling electronic devices using gestures is provided. This system comprises several key components working in concert to detect, capture, analyze, and translate user gestures into executable commands. The system includes a wearable device worn by a user, which incorporates one or more sensors configured to detect hand or finger movements. Additionally, the system comprises one or more cameras configured to capture gestures of the user from various angles. A processing module is tasked with analyzing the detected hand or finger movements and the captured gestures to recognize a plurality of user-specific gestures. A machine learning module is then used to translate the recognized gestures into one or more commands for a plurality of connected electronic devices. Finally, the system includes a communication module configured to transmit the translated commands to the connected devices for execution, ensuring precise and responsive control based on the user's gestures.

Another aspect of the present disclosure is directed to a non-transitory computer-readable medium storing instructions that, when executed by one or more processors, cause a system to perform a method for controlling electronic devices using gestures. The method involves several critical steps aimed at detecting, capturing, analyzing, translating, and executing gestures. It begins with detecting one or more hand or finger movements of a user via sensors integrated into a wearable device worn by the user. Next, the method captures one or more gestures of the user through cameras positioned either on the user or in the user's environment to provide comprehensive coverage. The captured data is then analyzed to recognize a plurality of user-specific gestures using a processing module. These recognized gestures are translated into one or more commands for connected electronic devices by leveraging a machine learning algorithm. Finally, the method ensures the execution of these commands on the connected devices, thereby facilitating intuitive and efficient control based on the user's gestures.

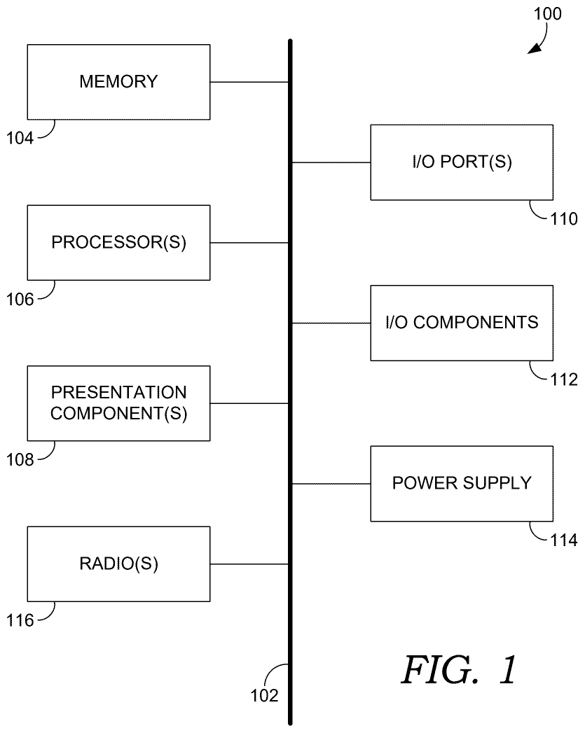

Referring to the drawings in general, and initially to FIG. 1, an exemplary computing environment 100 suitable for practicing embodiments of the present technology is provided. Computing environment 100 is just one example, and is not intended to suggest any limitation as to the scope of use or functionality of the embodiments discussed herein. Furthermore, the computing environment 100 should not be interpreted as having any dependency or requirement relating to any one or a combination of components illustrated. It should be noted that although some components in FIG. 1 are shown in the singular, they might be plural. For example, the computing environment 100 might include multiple processors and/or multiple radios. As shown in FIG. 1, computing environment 100 includes a bus 102 that directly or indirectly couples various components together, including memory 104, processor(s) 106, presentation component(s) 108 (if applicable), radio(s) 116, input/output (I/O) port(s) 110, input/output (I/O) component(s) 112, and power supply 114. More or fewer components are possible and contemplated, including in consolidated or distributed form.

Memory 104 may take the form of memory components described herein. Thus, further elaboration will not be provided here, but it should be noted that memory 104 may include any type of tangible medium that is capable of storing information, such as a database. A database may be any collection of records, data, and/or information. In one embodiment, memory 104 may include a set of embodied computer-executable instructions that, when executed, facilitate various functions or elements disclosed herein. These embodied instructions will variously be referred to as “instructions” or an “application” for short. Processor 106 may actually be multiple processors that receive instructions and process them accordingly. Presentation component 108 may include a display, a speaker, and/or other components that may present information (e.g., a display, a screen, a lamp (LED), a graphical user interface (GUI), and/or even lighted keyboards) through visual, auditory, and/or other tactile cues.

Radio 116 may facilitate communication with a network, and may additionally or alternatively facilitate other types of wireless communications, such as those that use unlicensed spectrum (e.g., Wi-Fi, WiMAX) cellular signaling (e.g., LTE, 5G, 6G), and short-distance communication (e.g., Bluetooth, NFC), including packet-switched technology such as voice over IP (VoIP). In various embodiments, the radio 116 may be configured to support multiple technologies, and/or multiple radios may be configured and utilized to support multiple technologies. The input/output (I/O) ports 110 may take a variety of forms. Exemplary I/O ports may include a USB jack, a stereo jack, an infrared port, a firewire port, other proprietary communications ports, and the like. Input/output (I/O) components 112 may comprise keyboards, microphones, speakers, touchscreens, and/or any other item usable to directly or indirectly input data into the computing environment 100. Power supply 114 may include batteries, fuel cells, and/or any other component that may act as a power source to supply power to the computing environment 100 or to other network components, including through one or more electrical connections or couplings. Power supply 114 may be configured to selectively supply power to different components independently and/or concurrently.

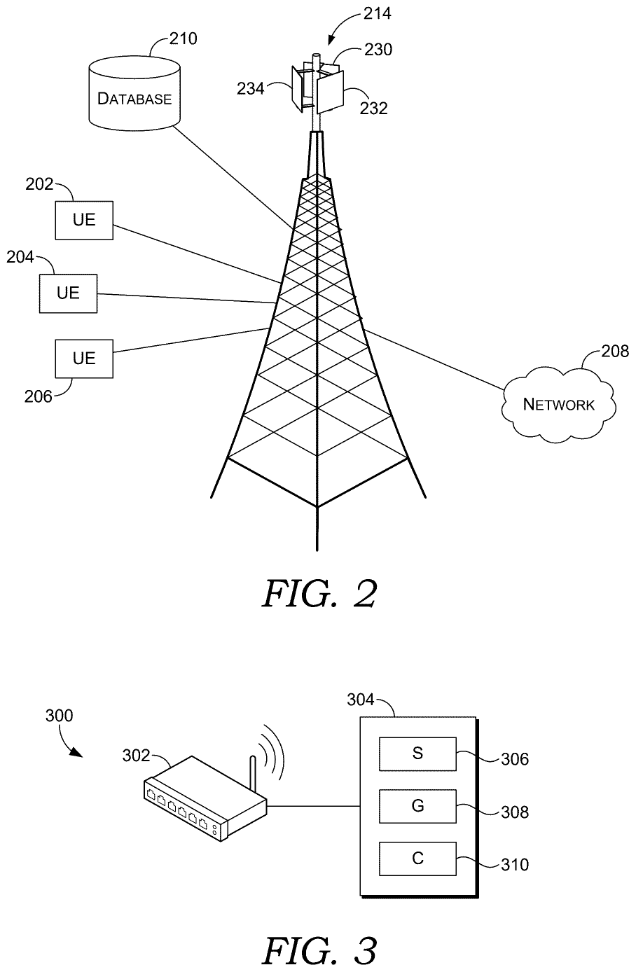

FIG. 2 provides an exemplary network environment in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 includes one or more user devices (e.g., user devices 202, 204, and 206), cell site 214, network 208, database 210, and dynamic mitigation engine 212. In network environment 200, user devices may take on a variety of forms, such as a personal computer (PC), a user device, a smart phone, wearable devices (e.g., a smart watch, smart ring, smart bracelet, etc.), a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, an access point, and any combination of these delineated devices, or any other device that communicates via wireless communications with a cell site 214 in order to interact with a public or private network.

In some aspects, the user devices 202, 204, and 206 correspond to computing device 100 in FIG. 1. Thus, a user device may include, for example, a display(s), a power source(s) (e.g., a battery), a data store(s), a speaker(s), memory, a buffer(s), a radio(s) and the like. In some implementations, the user devices 202, 204, and 206 comprises a wireless or mobile device with which a wireless telecommunication network(s) may be utilized for communication (e.g., voice and/or data communication). In this regard, the user device may be any mobile computing device that communicates by way of a wireless network, for example, a 3G, 4G, 5G, LTE, 6G, CDMA, or any other type of network.

In other aspects, the user devices 202, 204, and 206 encompass a diverse range of high-throughput and high data consumption devices, catering to various user needs and environments. In aspects, each of the user devices 202, 204, and 206 may take different forms, such as a fixed wireless device, wearable device, an IoT device, or any other device that may be capable of communicating with the network, processing data, and interacting with other connected devices within the system.

Additionally, device 206 can be any device characterized by high data throughput needs, such as advanced gaming consoles that require rapid data exchange for real-time multiplayer experiences, or professional-grade video conferencing systems used in businesses for high-quality virtual meetings. This category also includes emerging Internet of Things (IoT) devices, like intelligent security cameras and smart home appliances, which constantly transmit and receive data for automation and monitoring purposes. Furthermore, high-performance tablets and laptops also fall under this category, as they require high-speed internet for cloud computing and large file transfers.

In some cases, the user devices 202, 204, and 206 in network environment 200 may optionally utilize network 208 to communicate with other computing devices (e.g., a mobile device(s), a server(s), a personal computer(s), etc.) through cell site 214. The network 208 may be a telecommunications network(s), or a portion thereof. A telecommunications network might include an array of devices or components (e.g., one or more base stations), some of which are not shown. Those devices or components may form network environments similar to what is shown in FIG. 2, and may also perform methods in accordance with the present disclosure. Components such as terminals, links, and nodes (as well as other components) may provide connectivity in various implementations. Network 208 may include multiple networks, as well as being a network of networks, but is shown in more simple form so as to not obscure other aspects of the present disclosure.

Furthermore, network environment 200 supports advanced human-device interaction mechanisms. For example, any of all of the user devices 202, 204, and 206 can be wearable devices within the network 208. These can be devices such as smartwatches or augmented reality (AR) headsets. Each of the user devices can detect user movement such as hand and finger movements through integrated sensors in the wearable device. The user devices 202, 204, and 206 can also capture gestures using embedded cameras. Additionally, user devices 202, 204, and 206 can be cameras, motion detectors, or other environmental sensors within a room, home, or environment where the user is located or near. The gestures and motions are analyzed by AI-driven algorithms to recognize specific commands, which are then translated into actionable instructions for various connected electronic devices, that can be user devices 202, 204, and 206.

Network 208 may be part of a telecommunication network that connects subscribers to their service provider. In aspects, the service provider may be a telecommunications service provider, an internet service provider, or any other similar service provider that provides at least one of voice telecommunications and data services to any or all of the user devices 202, 204, and 206. For example, network 208 may be associated with a telecommunications provider that provides services (e.g., LTE, 4G, 5G, 6G) to the user devices 202, 204, and 206. Additionally or alternatively, network 208 may provide voice, SMS, and/or data services to user devices or corresponding users that are registered or subscribed to utilize the services provided by a telecommunications provider. Network 208 may comprise any communication network providing voice, SMS, and/or data service(s), using any one or more communication protocols, such as a 1×circuit voice, a 3G network (e.g., CDMA, CDMA2000, WCDMA, GSM, UMTS), a 4G network (WiMAX, LTE, HSDPA), a 5G network, or a 6G network. The network 208 may also be, in whole or in part, or have characteristics of, a self-optimizing network.

In some implementations, cell site 214 is configured to communicate with the user devices 202, 204, and 206 that are located within the geographical area defined by a transmission range and/or receiving range of the radio antennas of cell site 214. The geographical area may be referred to as the “coverage area” of the cell site or simply the “cell,” as used interchangeably hereinafter. Cell site 214 may include one or more base stations, base transmitter stations, radios, antennas, antenna arrays, power amplifiers, transmitters/receivers, digital signal processors, control electronics, GPS equipment, and the like. In particular, cell site 214 may be configured to wirelessly communicate with devices within a defined and limited coverage area. In an exemplary aspect, the cell site 214 comprises a base station that serves at least one sector of the cell associated with the cell site 214, and at least one transmit antenna for propagating a signal from the base station to one or more of the user devices 202, 204, and 206. In other aspects, the cell site 214 may comprise multiple base stations and/or multiple transmit antennas for each of the one or more base stations, any one or more of which may serve at least a portion of the cell. For example, the cell site may comprise a first antenna array 230, a second antenna array 232, and a third antenna array 234, wherein each of the antenna arrays serves a distinct sector (i.e., portion) of the coverage area of the cell 214. In some aspects, the cell site 214 may comprise one or more macro cells (providing wireless coverage for users within a large geographic area) or it may be a small cell (providing wireless coverage for users within a small geographic area).

One of the user devices may function as a centralized home automation hub. This hub is designed to connect and manage a plurality of smart devices within a household, including but not limited to lighting systems, thermostats, security cameras, door locks, home entertainment systems, kitchen appliances, and other IoT devices. The home automation hub serves as the central point of control and coordination, allowing users to interact with and manage these devices through a unified interface. The hub can communicate with these devices using various wireless communication protocols such as Wi-Fi, Zigbee, Z-Wave, Bluetooth, cellular networks, and other wireless or wired protocols.

The centralized home automation hub leverages the advanced human-device interaction capabilities described earlier. By integrating gesture recognition and natural language processing, the hub allows users to control their smart home devices through intuitive commands. For instance, a user can adjust the lighting in a room by simply waving their hand or issue a verbal command to lock the doors. The AI-driven algorithms within the hub continuously learn from the user's behavior patterns and environmental contexts, enabling the system to anticipate user needs and make preemptive adjustments. For example, the hub might automatically dim the lights and lower the thermostat when it recognizes that the user typically prefers a more relaxed environment in the evening. In aspects, the gesture recognition may be configured to recognize and translate standardized sign language gestures (e.g., American Sign Language (ASL)) into computer-executable commands or inputs; in other aspects, the gesture recognition may be configured to learn/create an index of user-specific gestures that equate to computer-executable commands.

Additionally, the home automation hub can function as a mediator between different devices, ensuring seamless interoperability and coordination. It can receive data from various sensors and devices, process this data to determine the appropriate actions, and then relay commands to the relevant devices. For example, if a security camera detects motion outside the house, the hub can turn on the exterior lights, lock the doors, and send a notification to the user's smartphone. The hub can also integrate with external services such as weather forecasts and energy management systems to optimize the operation of home devices. For instance, it might adjust the heating schedule based on weather predictions or manage the use of high-energy appliances to coincide with off-peak electricity rates.

In some implementations, the home automation hub also includes a user-friendly interface accessible via a dedicated touchscreen panel, a smartphone app, or a web portal. This interface allows users to configure and monitor their smart home system, set up automation routines, and receive real-time alerts and notifications. The interface may also provide insights and recommendations based on the data collected from the connected devices, helping users to make informed decisions about their home management. Overall, the centralized home automation hub enhances the convenience, security, and efficiency of smart home systems by providing a comprehensive and integrated control solution.

FIG. 3 provides an exemplary network environment in which implementations of the present disclosure may be employed. Such a network environment is illustrated and designated generally as network environment 300. Network environment 300 is but one example of a suitable network environment and is not intended to suggest any limitation as to the scope of use or functionality of the invention. Neither should the network environment be interpreted as having any dependency or requirement relating to any one or combination of components illustrated. The network environment 300 includes a UE 302 that is capable of operating in network environment 300. The UE 302 can be a home automation hub or other device that can link up with other home devices, such as smart lights, thermostats, security systems, and other internet of things (IoT) devices. The network environment 300 additionally comprises a processing module 304 installed within the UE 302. The processing module 304 comprises a sensor module 306, a gesture recognition module 308, and a command execution module 310.

A connected device can also request a specific command. Upon receiving the request from a connected device for specific commands, the sensor module 306 initiates a process to detect current gestures. It requests updated movement data and captures new gestures, allowing the gesture recognition module 308 to recalibrate and generate accurate commands. This real-time detection process is optimized to minimize latency and provide immediate response to user inputs. The system employs low-power techniques to ensure energy efficiency, extending the battery life of the wearable device and other components.

In some embodiments, the processing module 304 includes a mechanism for generating an alert on the UE 302 indicating that a command has been processed. This alert informs the user that their gestures have been recognized and executed, providing transparency and user awareness. The alert can be in the form of visual notifications, audio cues, or haptic feedback, ensuring the user receives immediate confirmation of the system's response. The alert mechanism can be customized based on user preferences and accessibility requirements.

The sensor module 306 is responsible for detecting one or more movements of a user. This detection can be done by one or more sensors integrated into a wearable device worn by the user, such as a smartwatch or a fitness tracker. These sensors can include accelerometers, gyroscopes, magnetometers, and optical sensors that track the motion and orientation of the user's body, hand, or fingers. Specifically, the sensor module 306 identifies the movements by processing data from these sensors in real-time and transmits the processed data to the gesture recognition module 308 via a wireless or wired connection, such as Bluetooth or a dedicated communication interface.

The gesture recognition module 308 captures one or more gestures of the user using one or more cameras. These cameras can be integrated into the UE 302 or positioned in the user's environment to provide multiple angles of view. The gesture recognition module 308 analyzes the captured gestures and the detected hand or finger movements using a machine learning algorithm to recognize a plurality of specific gestures. This recognition process involves several key steps. Firstly, it captures the gestures using high-resolution cameras that provide detailed movement data, including depth and spatial information. Secondly, the module processes the combined sensor and camera data using advanced algorithms, such as convolutional neural networks (CNNs) and recurrent neural networks (RNNs), to accurately identify specific gestures. These algorithms are trained on large datasets of gesture patterns to ensure high accuracy and reliability. The training of these algorithms can be done at a population level to capture a wide variety of gesture patterns, ensuring general applicability and robustness. However, a hybrid approach can also be used, where once a threshold amount of overlapping similarities between a user's gestures and the broader dataset is detected, a more specialized model—tailored to that specific group of users—is pulled in to enhance accuracy and relevance for that user segment The machine learning algorithm used by the gesture recognition module 308 is designed to learn and adapt to the user's unique gesture patterns over time. Initially, the system uses a pre-trained gesture library that includes a wide variety of common gestures. When a gesture is detected by the camera or sensors, the system generates a hypothesis about its meaning based on the existing library. For example, if the system detects that the user has gestured to the right with one finger raised, it might guess that this gesture means to skip a track. The user is then prompted to confirm or correct this guess. The system presents a query through the UE 302 or an associated display, asking if the guessed command is correct. The user can respond with a yes or no. If the user confirms the guess, the gesture is added to the personalized gesture library. If the user denies it, the system adjusts its hypothesis and continues to learn from further inputs.

The machine learning model continuously refines the gesture library based on user feedback. The model uses reinforcement learning techniques, where correct guesses are rewarded and incorrect ones are penalized. This feedback loop enables the model to improve its accuracy and adapt to the user's specific gesture style and preferences. Over time, the model becomes more proficient at recognizing and interpreting the user's gestures, providing a more intuitive and responsive user experience.

Once a specific gesture is confirmed and recognized, the machine learning algorithm translates it into one or more commands for a plurality of connected electronic devices. This translation process involves mapping the recognized gesture to predefined commands stored in a command database, which can be customized by the user or the service provider. The command execution module then securely transmits these commands to the connected devices using secure protocols such as HTTPS, MQTT, or CoAP.

During the training phase, the CNN layers work to extract spatial features from video frames, identifying key points and contours of hand movements. Each frame of a gesture video is processed to detect and encode shapes and orientations of the hand, transforming raw pixel data into a structured form that highlights essential gesture characteristics. In parallel, the sensor data, which includes time-series inputs from accelerometers, gyroscopes, and other motion sensors, is processed by RNN layers. RNNs are particularly suited for this task due to their ability to handle sequences of data, capturing the dynamic temporal behaviors of gestures. The temporal patterns recognized by RNNs include the speed, rhythm, and sequence of movements, all crucial for understanding the flow and progression of gestures over time.

After initial feature extraction, the CNN and RNN outputs are fused in a later stage of the network, which combines spatial and temporal features to form a comprehensive feature set. This fusion is critical as it allows the model to correlate specific hand positions with their movement trajectories, enhancing the accuracy of gesture recognition. The combined features then pass through additional neural network layers that perform classification. These layers are responsible for interpreting the integrated features and mapping them to specific gestures predefined in the system's gesture library. The classification process uses techniques such as softmax layers, which provide probabilities for each gesture type, allowing the system to make informed decisions about the most likely gestures performed by the user.

In deployment, the machine learning algorithm operates in real-time, processing incoming sensor and video data to recognize gestures as they occur. The real-time processing capability is enhanced by the use of optimized neural network models that are both computationally efficient and capable of running on lower-power devices, such as smartphones and wearable tech. Additionally, the gesture recognition module incorporates continuous learning mechanisms, where the algorithm periodically updates itself with new user data collected during operation. This ongoing learning process is facilitated by techniques such as online learning or transfer learning, where the model fine-tunes itself to adapt to the user's unique gesture style and any changes in their behavior over time.

The gesture recognition module 308 validates the captured gestures against a database of known gestures to ensure accuracy. This database contains a comprehensive library of gesture patterns, which are indexed and categorized based on their characteristics. The module employs machine learning techniques, such as anomaly detection and reinforcement learning, to refine the recognition process over time, improving the precision of the commands generated. The validation process includes cross-referencing captured gestures with multiple data points to reduce false positives and enhance reliability.

In other embodiments, the gesture recognition module 308 can log each recognition event along with a timestamp and send alerts to a network operator if anomalies or discrepancies are detected. This logging provides a detailed record of gesture data, useful for further analysis or troubleshooting. The alert mechanism ensures prompt notification of potential issues, maintaining service accuracy and reliability. The logged data can be analyzed to identify patterns and trends, contributing to the continuous improvement of the gesture recognition system.

The command execution module 310 is responsible for managing the execution of the recognized commands on the connected devices within the network. This module ensures seamless communication and interaction with the devices by utilizing secure communication protocols, such as Hypertext Transfer Protocol Secure (HTTPS), Message Queuing Telemetry Transport (MQTT), or Constrained Application Protocol (CoAP). These protocols are selected based on their ability to provide encryption and secure data transmission, thereby ensuring the integrity and confidentiality of the commands being executed.

Upon receiving a command from the gesture recognition module 308, the command execution module 310 interprets the command and determines the appropriate connected device to which the command should be relayed. This determination involves parsing the command to extract relevant information, such as the device identifier, command type, and any parameters associated with the command. The module then establishes a secure communication session with the targeted device using one of the aforementioned protocols.

For instance, when using HTTPS, the command execution module initiates a secure HTTP session with the device, ensuring that all data exchanged is encrypted using Transport Layer Security (TLS). Similarly, when employing MQTT, the module connects to an MQTT broker, which facilitates message transmission between the module and the device, ensuring secure and reliable delivery. CoAP, being optimized for constrained environments, provides a lightweight, yet secure communication channel for devices with limited resources.

Once the communication session is established, the command execution module transmits the command to the device in a format that the device can interpret and execute. The device, upon receiving the command, processes it according to its internal logic and performs the specified action. The module may also implement mechanisms for confirming the successful execution of commands, such as receiving acknowledgment messages from the device or monitoring the device's status for expected changes

The command execution module 310 includes error-handling mechanisms to detect and correct any issues during command transmission and execution. It also maintains a log of executed commands for auditing and troubleshooting purposes. The command execution module 310 ensures the privacy and integrity of the user's data by employing encryption techniques, such as AES or RSA, to protect the communication channels.

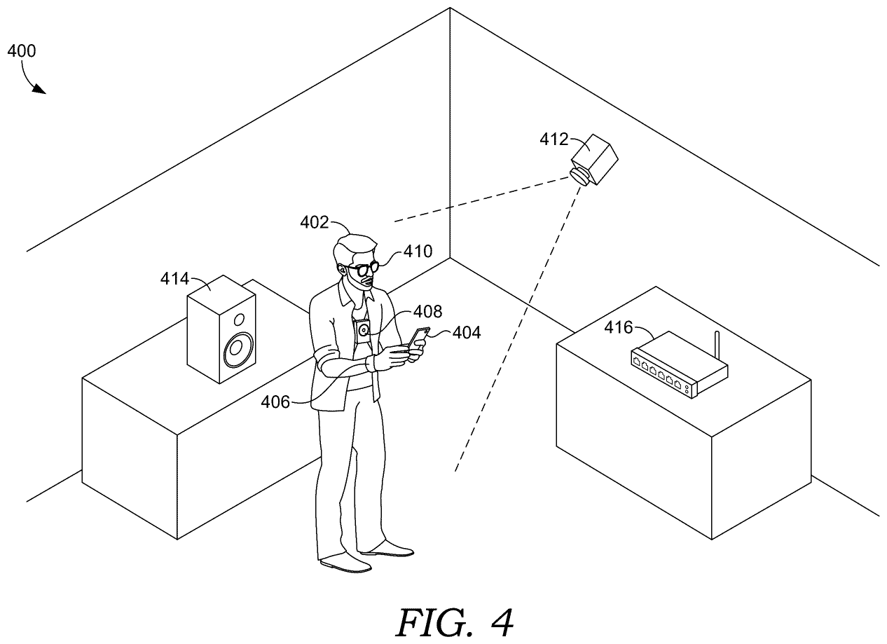

FIG. 4 illustrates an example environment 400 in which the system described in FIG. 3 operates to detect, analyze, and respond to user gestures and movements using various interconnected components. This environment demonstrates the practical implementation of the system, highlighting how user inputs are processed to control connected devices.

In this example environment, a user 402 interacts with the system using multiple devices. The user 402 carries a UE 404, which, in this embodiment, is a smartphone. The user 402 wears a wearable device 406, depicted as a bracelet, equipped with multiple sensors, including accelerometers, gyroscopes, magnetometers, and optical sensors. These sensors continuously detect and transmit hand and finger movements. Additionally, the user 402 has a personal camera 408 attached to their body, providing detailed visual data of gestures from different angles. The user 402 also wears smart glasses 410, which incorporate cameras and other sensors, offering an augmented reality (AR) interface for real-time feedback and interaction with virtual elements. A fixed camera 412 is positioned to monitor the user 402's movements within a specific area, offering an additional perspective to enhance gesture recognition accuracy. This camera, along with the personal camera 408 and the sensors in the wearable device 406, sends data to the UE 404, which processes and integrates this information.

The connected device 414, such as a smart speaker, receives commands based on the determined gestures. This device is part of a broader ecosystem of IoT devices that can execute various commands, such as playing music, adjusting lighting, or controlling temperature. The central hub 416 links all these components, managing data flow and processing within the environment. The central hub 416 integrates data from the various sensors and devices, processes it using the machine learning algorithms described in FIG. 3, and securely transmits commands to the connected devices.

The operational process begins with the sensor module within the wearable device 406 detecting movements. This data is transmitted to the UE 404 via a wireless connection, such as Bluetooth. Simultaneously, the personal camera 408 and smart glasses 410 capture visual data of the gestures, while the fixed camera 412 monitors the overall movements of the user 402. The gesture recognition module within the central hub 416 employs a machine learning algorithm to analyze the combined sensor and visual data. The algorithm extracts spatial features from the video frames, identifying key points and contours of the hand movements. Concurrently, the algorithm processes the time-series data from the sensors to capture the dynamic temporal behaviors of the gestures.

The machine learning algorithm integrates the spatial and temporal features, allowing it to accurately identify specific gestures. For example, if the user 402 gestures to the right with one finger raised, the system might initially hypothesize that this gesture means to skip a track. The UE 404 then prompts the user 402 to confirm this hypothesis via an interface on the smartphone or smart glasses 410. The user 402 can respond with a yes or no, providing immediate feedback to refine the gesture library. Based on the user's feedback, the machine learning model adjusts and improves its accuracy. If the gesture is confirmed, it is added to the personalized gesture library. If not, the system re-evaluates and adjusts its hypothesis. This reinforcement learning process ensures that the system becomes increasingly accurate and tailored to the user's unique gesture patterns.

Once the specific gesture is recognized and confirmed, the machine learning algorithm translates it into one or more commands for the connected device 414. The command execution module within the UE 404 securely transmits these commands using protocols such as HTTPS, MQTT, or CoAP. For example, upon recognizing the gesture to skip a track, the UE 404 sends a command to the smart speaker to play the next song.

The command execution module ensures the commands are executed correctly on the connected device 414, incorporating error-handling mechanisms to detect and resolve any issues during transmission and execution. Real-time feedback is provided to the user 402 through the smart glasses 410, confirming that the gesture has been recognized and the command executed.

The central hub 416 also manages continuous learning and updates for the machine learning model. It periodically collects new gesture data, fine-tuning the model to adapt to the user's unique gesture style and any changes in behavior. This ongoing learning process ensures the system remains accurate and responsive over time.

This detailed example illustrates how the system described in FIG. 3 operates within an interconnected environment, processing user gestures through various sensors and cameras, translating them into commands, and executing these commands on connected devices efficiently and securely. The integration of multiple sensor inputs and advanced machine learning techniques ensures robust and accurate gesture recognition, providing an intuitive and seamless user experience.

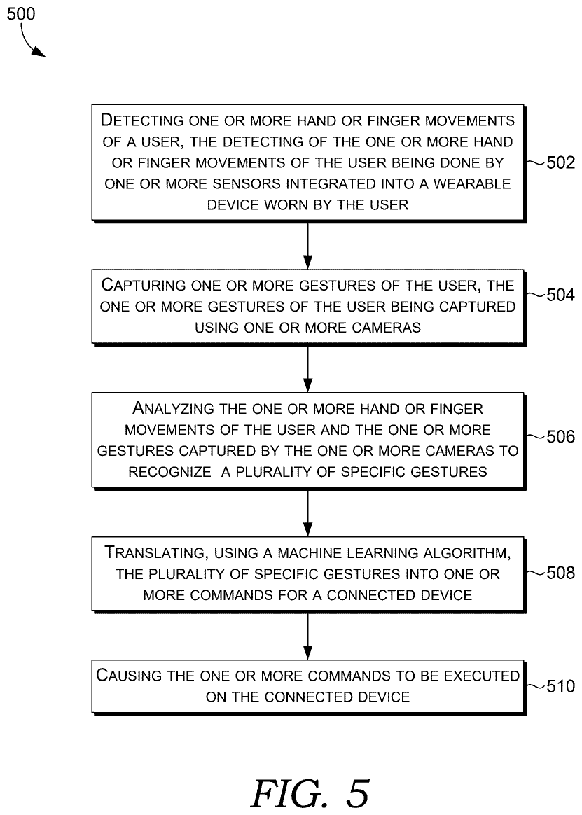

Turning now to FIG. 5, a flow chart is provided that illustrates one or more aspects of the present disclosure relating to a method 500 for detecting and interpreting user gestures to control connected electronic devices. The method 500 begins at block 502 with the detection of one or more hand or finger movements of a user. This detection is accomplished using one or more sensors integrated into a wearable device worn by the user, such as a smartwatch or bracelet. These sensors can include accelerometers, gyroscopes, magnetometers, and optical sensors, which monitor the motion and orientation of the user's hand and fingers in real-time.

At block 504, the method involves capturing one or more gestures of the user using one or more cameras. These cameras can be integrated into the user's environment, such as a personal camera attached to the user's body, smart glasses worn by the user, or fixed cameras in the user's vicinity. The cameras provide multiple angles and perspectives of the user's hand and finger movements, capturing detailed visual data essential for accurate gesture recognition.

The method proceeds to block 506, where the system analyzes the detected hand or finger movements and the captured gestures using advanced machine learning algorithms. The system can use CNNs to extract spatial features from the video frames, identifying key points and contours of the hand movements. Simultaneously, RNNs can be use to process the time-series data from the sensors, capturing the dynamic temporal behaviors of the gestures. By integrating the spatial and temporal features, the machine learning algorithm can recognize a plurality of specific gestures accurately.

At block 508, the recognized gestures are translated into one or more commands for a plurality of connected electronic devices. This translation process is facilitated by a secondary machine learning model that maps the recognized gestures to specific commands. The model continuously learns and adapts based on user feedback, improving its accuracy over time. For instance, if the system detects a gesture of pointing to the right with one finger raised, it might hypothesize that the user wants to skip a track. The user can confirm or correct this hypothesis, allowing the system to refine its gesture-command mappings.

The method continues at block 510 with the execution of the translated commands on the connected devices. The system securely transmits the commands to the device(s). For example, the command to skip a track is sent to a connected smart speaker, which then performs the action. The system includes error-handling mechanisms to ensure that the commands are executed correctly, and provides real-time feedback to the user through devices like smart glasses or a smartphone interface.

In this example, the wearable device detects the user raising one finger and moving it to the right, indicating a gesture. The cameras capture this gesture from various angles, and the machine learning algorithm analyzes the combined data. The system hypothesizes that the gesture means to skip the current track and prompts the user for confirmation. The user confirms the gesture's meaning, and the system records this information, updating its gesture library. The command to skip the track is then securely transmitted to the smart speaker, which executes the action, and the user is notified of the successful command execution via a notification on their smart glasses.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

1. A method for controlling electronic devices using gestures comprising:
detecting one or more movements of a user;
determining, using a machine learning algorithm, one or more user specific gestures based on the one or more movements of the user;
generating, based on the one or more user specific gestures, a hypothesis regarding a meaning of the one or more user specific gestures;
prompting the user to confirm or correct the hypothesis;
receiving, from the user, a response indicating whether the hypothesis is correct;
updating a personalized gesture library based on the response from the user;
generating one or more commands for a connected electronic device based on the one or more user specific gestures; and
causing the one or more commands to be executed on the connected electronic device.

2. The method of claim 1, the detecting the one or more movements of the user being done by one or more sensors integrated into a wearable device worn by the user.

3. The method of claim 1, further comprising capturing one or more gestures using one or more cameras, the gestures being used to determine the one or more user specific gestures.

4. The method of claim 3, wherein the one or more cameras are positioned in a user's environment to provide multiple angles of view.

5. The method of claim 4, wherein the one or more cameras are positioned on the user.

6. The method of claim 1, further comprising storing the one or more user specific gestures and the one or more commands in a gesture library.

7. The method of claim 6, wherein the gesture library is updated based on a user feedback.

8. The method of claim 6, wherein the generating the one or more commands is performed using a neural network trained on a large dataset of gesture-command pairs.

9. The method of claim 1, wherein the generating the one or more commands comprises mapping the gestures to predefined commands stored in a command database.

10. The method of claim 9, wherein the command database is customizable by the user or a service provider.

11. The method of claim 1, wherein the generating the one or more commands comprises a reinforcement learning model that adjusts the machine learning algorithm based on a behavior of the user.

12. A system for controlling electronic devices, the system comprising:
a wearable device worn by a user, the wearable device including one or more sensors configured to detect movements of the user;
one or more cameras configured to capture gestures of the user;
a processing module configured to recognize one or more user specific gestures from the movements of the user and the gestures of the user, wherein the processing module is further configured to generate a hypothesis regarding a meaning of the one or more user specific gestures and prompt the user to confirm or correct the hypothesis;
a personalized gesture library configured to store the one or more user specific gestures, wherein the personalized gesture library is updated based on a response from the user indicating whether the hypothesis is correct;
a machine learning module configured to translate the one or more user specific gestures into one or more commands for a connected electronic device; and
a communication module configured to transmit the one or more commands to the connected electronic device for execution.

13. The system of claim 12, wherein the processing module uses a gesture machine learning model to recognize the one or more user specific gestures.

14. The system of claim 13, wherein the gesture machine learning model uses reinforcement learning to learn to determine the one or more user specific gestures.

15. The system of claim 12, wherein the processing module determines one or more user-specific gesture patterns.

16. The system of claim 15, wherein the one or more user-specific gesture patterns are stored in a personalized gesture library.

17. A non-transitory computer-readable medium storing instructions that, when executed by one or more processors, cause a system to perform a method for controlling electronic devices using gestures, the method comprising:
detecting one or more hand or finger movements of a user, the one or more hand or finger movements of the user being detected by one or more sensors integrated into a wearable device worn by the user;
capturing one or more gestures of the user, the one or more gestures of the user being captured using one or more cameras;
determining one or more user specific gestures based on the one or more hand or finger movements of the user and the one or more gestures;
generating, based on the one or more user specific gestures, a hypothesis regarding a meaning of the one or more user specific gestures;
prompting the user to confirm or correct the hypothesis;
receiving, from the user, a response indicating whether the hypothesis is correct;
updating a personalized gesture library based on the response from the user;
translating, using a machine learning algorithm, the one or more user specific gestures into one or more commands for a connected electronic device; and
causing the one or more commands to be executed on the connected electronic device.

18. The non-transitory computer-readable medium of claim 17, wherein the machine learning algorithm is trained based on a user's unique gesture patterns through feedback mechanisms and reinforcement learning.

19. The non-transitory computer-readable medium of claim 18, wherein the feedback mechanisms comprises a user confirmation or a correction of the one or more gestures.

20. The non-transitory computer-readable medium of claim 17, wherein the method further comprises storing the one or more user specific gestures and the one or more commands in a gesture library.
